(19) United States
(12) Patent Application Publication
(10) Pub. No.: US 2008/0265589 A1
(43) Pub. Date: Oct. 30, 2008

(54) Window Securing Means and Methods

(76) Inventors: Edvardsen Allan, Skanderborg (DK); Torben Allesen Pedersen, Horsens (DK)

Correspondence Address: CROCKETT & CROCKETT, P.C., 26020 ACERO, SUITE 200, MISSION VIEJO, CA, 92691, US

(21) Appl. No.: 11/996,309

(22) PCT Filed: Jul. 15, 2006
(86) PCT No.: PCT/EP2006/006958

§ 371 Date: Jun. 17, 2008

(30) Foreign Application Priority Data
Jul. 22, 2005 (EP) 05015961.5

(51) Int. Cl. E05C 19/16

(52) U.S. Cl. 292/251.5

(57) ABSTRACT

An assembly for securing an openable aperture closure member (11) in closed position relative to an aperture defined by a main frame (12). The assembly further includes a compressible gasket disposed between the closure member (11) and the frame (12) defining the aperture. Each of the aperture closure member (11) and the main frame (12) includes a respective portion (20, 42) of a magnetic means for securing said closure member (11) to the frame (12), wherein said magnetic means for securing includes a magnetic field in one portion (20) and a magnetically attractive portion (42), one of the magnetic field portion and the magnetically attractive portion being disposed on the openable closure member and thus being adapted to be movable by an operator with the openable closure member alternately into a magnetically attractive closure position and a magnetically unattractive opening position. The gasket is at least partially compressed when the closure member (11) is secured to the aperture, and the magnetic locking means (20, 42) overcoming the force needed to compress the gasket.

The present invention relates to securing and/or locking devices and/or methods used, for example, but not exclusively, for a pivotably openable window or like closure member, the securing/locking devices and methods being of a type having a magnetic securing and/or locking force to secure and/or lock a pivotably openable closure member within a stationary aperture frame, such as a pivotable window sash within a stationary window frame.

### BACKGROUND ART

Pivoting windows or other aperture closure members are well known and are widely used in walls or ceilings or roofs of buildings, inter alia. A locking mechanism arranged at an edge of the sash of a window or other aperture closure member is often used to prevent the sash from being opened unintentionally.

In various previous instances, as is described for example in EP1445403 and WO0196699, locking systems for windows, doors or the like, often included a movable locking member such as a pawl, a ratchet or the like, for cooperating with a striker plate, said striker plate having a recess, slot or the like for cooperating with the locking member in a locking position. To prevent break-ins etc., the locking member may often feature means for locking the locking member in relation to the striker plate, and said means, which may be a boss or an indentation, may have been designed to engage with a part of the striker plate. Other locking assemblies have also been described, as for example in WO03048487 or WO02053863 where a rotatable or swivellable handle has a locking member designed to pivotally engage a respective projection on a window frame or sash to lock the window in closed position.

Still further locking assemblies have included such as in WO04063498 which involves a lock assembly, especially for locking a window, a door or the like, comprising a base member, an operating member pivotally connected to the base member, a link member pivotally connected to the base member, a latch pivotally connected to both the link member and the operating member, said operating member being provided with a pivotable elongated handle bar having a first side facing the operating member. DK patent no. 168406 also discloses a lock assembly of the above type. A still further pivotable elongated handle bar lock actuating device is disclosed in EP0792991.

However, the designs of these or like prior lock mechanisms could be improved, particularly when it comes to ergonomics, and/or other effects on or undesirable results of manual manipulations in operation. Often, prior art designs have required the application of substantial manual forces to engage and secure or even to release the respective locking mechanisms thereof, particularly in those window constructions which include a resiliently compressible, hermetically sealing gasket provided between the frame and the sash. Such gaskets can require large forces for manipulation and/or can create a jarring, thus often disagreeable release effect to the operator. It is hence an object of the invention to provide a lock assembly having improved functionality with respect to ergonomics and simplicity in use.

### DISCLOSURE OF THE INVENTION

On this background, it is an object of the present invention to provide an openable closure member such as a door or window with improved ergonomic characteristics, particularly in alternately opening and then securing them in closed position. One or more of these objects may be achieved in accordance with claim 1 by providing a window or other openable aperture closure member with a magnetic securing means. Such a securing means eases the closing and securing process and/or contrarily simplifies the opening process.

Such a magnetic means may be made useful by a magnetic field which is cooperative with a magnetically attractive part to alternately securely hold and release an openable part within a stationary frame, as for example, a pivotable window sash in a stationary window frame.

In addition to the magnetic locking means for securing the sash structure to the frame structure, an auxiliary locking means for locking the sash structure to the frame structure may also be included.

Further objects, features, advantages and properties of a pivot window and actuation members and/or securing and/or locking devices according to the invention will become apparent from the detailed description.

### BRIEF DESCRIPTION OF THE DRAWINGS

In the following detailed portion of the present description, the invention will be explained in more detail with reference to the preferred embodiments shown in the drawings, in which:

FIG. 1 is a schematic isometric view of an embodiment of a pivotal window hereof in a closed position,

FIG. 2, which includes sub-part FIGS. 2A and 2B, provides further schematic isometric views of embodiments of one or more pivotal windows hereof in respective open positions,

FIG. 3 is a side elevational view of a sash and a frame along the longitudinal dimension of an embodiment hereof,

FIG. 4 is a side elevational view of a sash and a frame along the longitudinal dimension of an embodiment hereof,

FIG. 5 is a partially exploded isometric view of a locking and/or securing assembly hereof,

FIG. 6 is a partially broken plan view of a locking/securing assembly hereof,

FIG. 7 is an elevational view of a locking securing assembly according hereto, and

FIG. 8 is a graphical representation of force versus distance according hereto.

### DETAILED DESCRIPTION

The present invention relates generally to securing devices or systems for an aperture closure member such as a window or a door, the primary securing systems hereof including a magnetic securing device or assembly. Such a magnetic assembly may generally include a fixed magnetic field element and a movable magnetic field element which cooperate to alternately, first, engage and hold or secure the aperture closure member in closing position of said aperture, and second release and allow for opening of the closure member relative to the aperture. The invention further relates to an overall combination of an aperture and aperture closure member, such as a window or a door, the aperture being defined by a substantially fixed frame and the aperture closure member being a movable means such as a movable sash, said combination further including a magnetic securing device or system for alternately securing and releasing the aperture closure member relative to the aperture, e.g. for opening and closing said aperture.

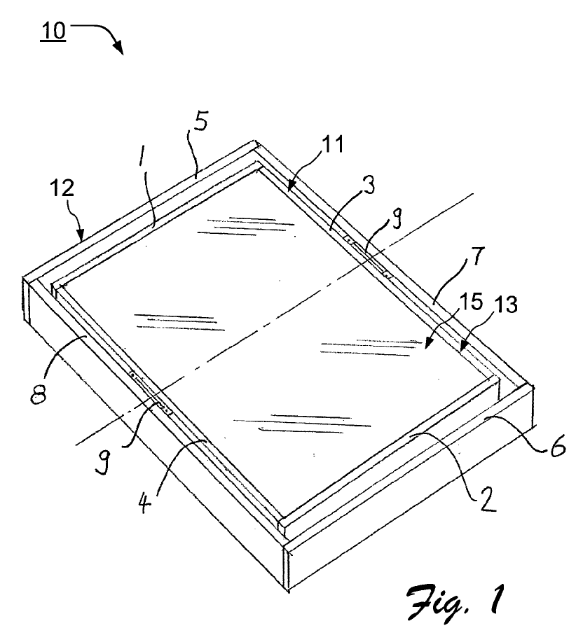

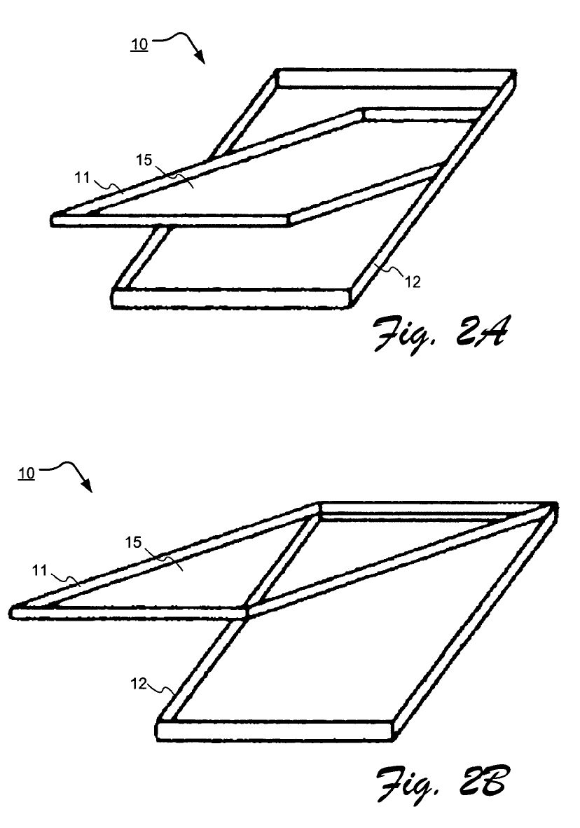

In the general embodiments shown in FIGS. 1-4, the combination or assembly of an aperture and an openable closure member therefor is generally identified with the reference numeral 10, the aperture being defined by a frame 12 and the closure member or window identified generally by the reference numeral 11. The combination 10 may be, as shown in the drawings according to a preferred embodiment of the invention, an openable window assembly 11 with a main, substantially stationary, or fixed frame structure 12 which includes a top member 5, a bottom member 6, and side members 7 and 8, and an openable sash structure 13 with a top member 1, a bottom member 2, and side members 3 and 4. The sash structure 13 carries a window pane 15 which together form the openable closure member 11 in the embodiments shown in the drawings.

By means of swing fittings or hinges 9, between the respective sash and frame side members 3, 4 and 7, 8; the sash structure 13 is pivotally journalled in the frame structure 12 with an axis of rotation which as shown, may be parallel with the top and bottom members and may be top or bottom hung or established substantially halfway (or at any other disposition) between them by means of the pivotal fittings 9. Moreover, as is known, the rotatable sash 13 may be alternatively (or even alternately; see FIG. 4 described below) journalled about alternate fittings 9 at or about the top or bottom members, or alternatively (or alternately) at a position at or about and/or parallel to the side members.

In a closed position, the sash 13 and closure member 11 are oriented substantially parallel with and are disposed within the window frame 12. In the closed position a securing and/or locking mechanism (alternatives of which being described further below) engages the sash 13 with the frame 12 to hold the sash 13 secure and/or locked closed relative to the frame 12. Note, in many preferred embodiments of window frames and corresponding sashes, a resilient and preferably circumferential gasket (not shown) is often provided between the frame 12 and the sash 13. The gasket is compressed when the sash is in the closed position in order to provide a substantially hermetic seal between the frame 12 and the sash 13.

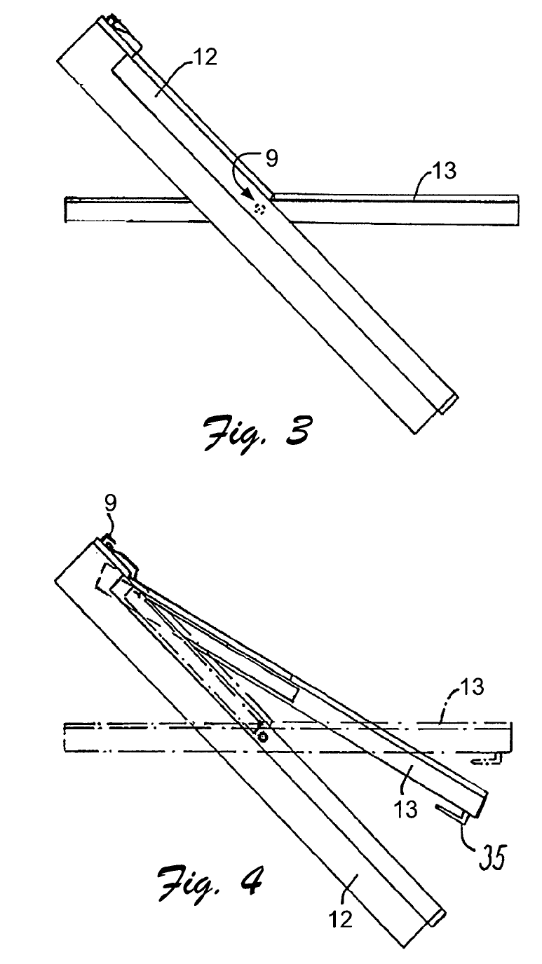

In FIGS. 3 and 4, schematic side views of the window assembly 10 as a combined turn/pivot window are shown, in which the sash structure 13 and the window/closure member 11 under normal use may be either top-hung or substantially centrally pivotal relative to the frame structure 12, or alternately both. Thus, both pivotal positions are shown in dashed lines in FIG. 4, with the central alternative shown in a solid line in FIG. 3. In either case, it may be that the window/closure member 11 may function as a pivot window which is manually openable and closable through use of a handle member here shown, FIG. 4, represented by handle 35 on the interior side of the sash bottom member. Note, the handle 35 may be top or bottom or otherwise situated.

To make it possible to swing the window sash through a large angle (e.g., as much as approximately 90 or even 180 degrees) to a convenient open position, the sash structure 13 may be pivotally connected with intermediate hinge members 9 often positioned substantially centrally between the upper and lower parts of the sash and frame side members 3, 4 and 7, 8, respectively. Note, during normal use of the window, either the top-hung or centrally-disposed hinges may be used (as alternatively could bottom disposed hinges or hinges disposed in the respective top and bottom members 1, 2 and 5, 6). The axis of rotation of the substantially central swingable connection lies approximately halfway between the top and bottom members in the same manner as shown in FIGS. 3 and 4, and operation of the window to this pivot or swing movement is carried out in a manner frequently used in connection with roof windows, inter alia.

Note, the handle assembly 35, as shown in the drawings, see FIGS. 3 and 4, may be disposed in a substantially horizontal disposition, i.e., operably parallel to the top and/or bottom members 1, 2 and 5, 6 of the sash and frame, and may be disposed at or adjacent the top members 1, 5 (not shown), or may be disposed at or about or adjacent the bottom members 2, 6 as shown in FIGS. 3 and 4. Note also, though not shown (and perhaps less preferred), the handle bar assembly 35 could be disposed at various dispositions top to bottom horizontally, or the handle bar member 35, or the like could be disposed in a lengthwise position parallel with the side members 3, 4 and 7, 8, and adjacent one or the other sides 3, 7 or 4, 8. Even so, it should be noted that these alternatives may have a variety of functional distinctions or restrictions not required or impacted by the preferred top and/or bottom horizontal dispositions shown and initially described here.

In the primary embodiments described herein, the handlebar assembly 35 is connected to the movable sash 13, in many cases on or to the bottom or top member 1 or 2 as described further below. In such cases connected to the movable sash, the assembly 35 may provide for maneuvering the movable sash 13, i.e., alternately into open and closed positions.

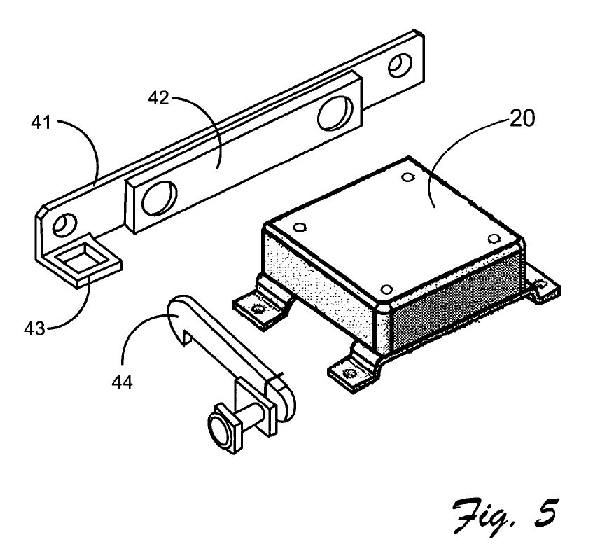

A feature of a locking or securing device or assembly hereafter referred to generally using the reference numeral 20 involves magnetism. Details of such will be described with particular reference to FIGS. 5, 6 and 7. As shown in FIGS. 5-7, a magnetic securing means is depicted. Such an assembly may be a magnetic securing device/assembly 20 and a cooperating frame fixture 41 to be affixed (as by screws, nails or other means) to a corresponding fixed frame member, e.g., either top or bottom frame member 5 or 6 (not shown in FIGS. 5-7). The fixture may have, for example, a magnetically receptive metal portion forming an anchor 42 for cooperating with the magnetic device 20. Optionally also an eyelet 43 or other hook receiving portion may be disposed connected to the frame fixture 41 (or may otherwise be connected to the window frame) for receiving a securing hook 44, or the like, also described below. Note, the magnetically receptive portion 42 is generally active to be magnetically attractive to a magnet, and as such may itself be magnetic or merely of a material, e.g., metal or certain ceramics, inter alia, which is subject to magnetic forces.

Moving to a description of the interactions of the locking and/or securing mechanisms or systems, shown in FIGS. 5-7 are various views of a locking/securing device 20 of a magnetic type (see here also the frame fixture 41 and magnetic portion 42 thereof). Disposed within the assembly 20 is a magnetic member or element which provides a magnetic field, which as in many preferred examples, is a permanent magnet. The magnetic member generally includes a fixed magnetic field element or elements which works to alternately, first, engage and hold or securely connect with the magnetic portion 42 of the fixed frame member 41 to thereby secure the aperture closure member 11 in closing position of said aperture, and second release and allow for opening of the closure member 11 relative to the aperture.

The specific operational features of a preferred magnet assembly 20, which may also be known as a magnetic securing device 20, will now be described. As shown there, the magnetic locking/securing assembly 20 has an appropriate magnetic surface to seat against a surface of the magnetically attractive member 42 to which it will magnetically adhere.

In operation, first the magnet 20 is moved or placed adjacent a magnetically attractive surface, e.g., surface 42, FIG. 5, against which the magnetic device will adhere. When the magnet 20 is in this position, its magnetic flux is extended outside the device 20 through the active surfaces of the device. Accordingly, when the magnetic assembly 20 is thus placed adjacent the magnetically attractive surface it is magnetically attracted to the magnetically available surface (e.g., surface 42), and, as a result, the magnet 20 is fixedly secured to such surface, e.g., surface 42 of the frame fixture 41 (member 42 sometimes also known as an anchor 42 or armature 42).

When the fixture 41 is connected to the stationary frame 12 (at e.g., top or bottom member 5 or 6), the magnetic device 20 can secure or lock the window sash 13, via the top or bottom member 1, 2 thereof whichever has the magnetic device connected thereto, to the frame 12. The magnetic force of the magnetic device 20 may be such as to strongly resist opening, thus locking the sash against the frame, or may be of limited strength (depending upon available materials, for example) and thus provide more relative securing of the sash against the frame. An auxiliary or alternative locking device, e.g., a hookpiece 44, may then be used as described below. In any case, the mere push and pull activation by manual maneuvering of the handle to put the magnet 20 in position adjacent and typically into contact with the attractive part 42 may provide greater simplicity in operation and actuation of the alternate securing/locking and then unsecuring/unlocking feature, simplifying the overall maneuvering necessary by the human operator to both engage and disengage, and/or improving the overall ergonomics of the opening and/or closing of the closure member 11 relative to the aperture.

Note, as introduced, an auxiliary locking device may be used, e.g., for redundancy or to provide actual locking if the magnetic member 20 is not sufficiently strong to lock (e.g., rather than merely secure) the aperture closure member in closed position by itself. As shown in FIGS. 5, 6, and 7, the magnetic lock 20 may be used with an auxiliary locking device, particularly a latch or hook 44, thereby providing a secure stay device plus a lock device. The auxiliary locking member or mechanism, e.g., a latch 44, can be fixed to the movable sash and engage with the window frame. Latch 44 may be operated by conventional means so long as it is adapted to extend into a recess or eyelet 43 connected to or within the frame 12 as for example in either upper or lower member 5 or 6 (or in the respective side member 7 or 8) to secure the sash against undesired opening.

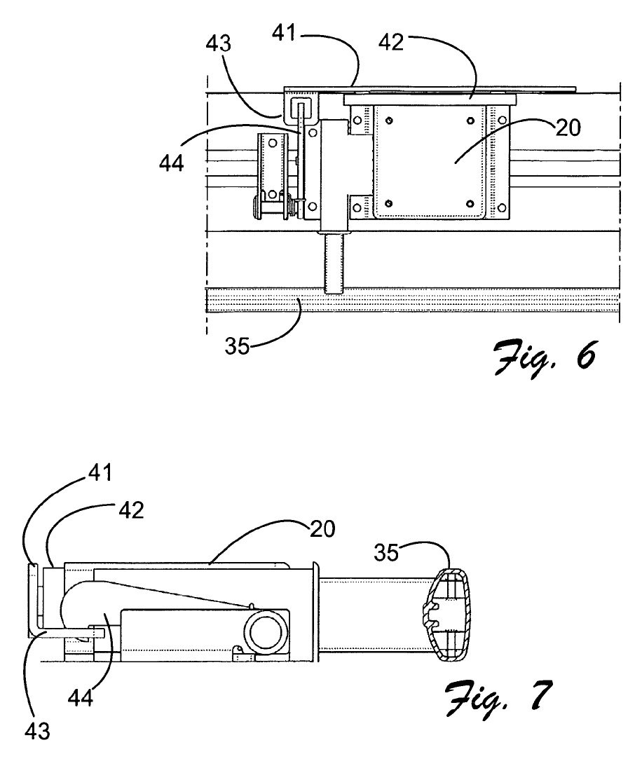

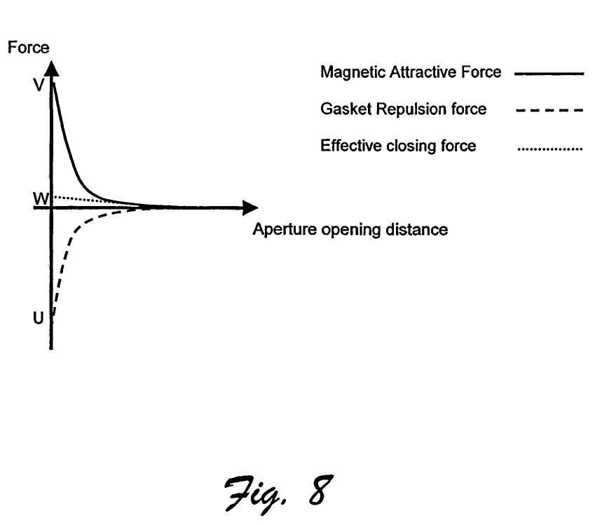

In more particular detail, a latch 44 may in some embodiments be biased, as by a spring, into a locking/latching position wherein the hook thereof would engage the recess or eyelet 43 (FIGS. 6 and 7). Then, the latch 44 may be rotatably movable against the spring-like bias to allow for opening movement of the sash 13. Note also that it may be desirable for there to be clearance between the hook of the latch 44 and the eyelet 43 such engagement of the hook with the eyelet only occurs when and if the magnetic securing force is overcome, as by an attempted break-in. Thus, so long as there is such clearance, then, the normal operation of the magnetic securing system will not have to overcome contact resistance of the latch. Thus, the magnetic system will be more ergonomically attractive, i.e., will require less manually-applied force for opening or closing.

Note, when a sealing gasket (not shown) is used as a sealing member between the frame and the sash, a considerable amount of force can often be necessary to be applied to and/or by a securing mechanism, such as may be necessary for use of a magnetic locking device 20 as shown and described here, to ensure that the gasket is properly and fully compressed for sealing closure. In the closed position, the contrary repelling force of the gasket that resists closure or otherwise urges the sash toward an open position (caused by the resilient pressure of the gasket exerted by the gasket on the sash 13) is preferably fully counteracted by the magnetic securing device 20 (i.e. the mechanical lock, including e.g. the latch 44, is preferably not loaded at any time by the force caused by the compressed gasket). In operation, the magnetic lock first overcomes the pressure of the gasket and thereafter, if used, the latch 44 may be used to catch the eyelet 43 when the sash is secured in closed position by the magnet. When the sash is opened, the order may preferably be reversed, so that the latch 44 may be disengaged from the eyelet 43 whilst the magnetic lock still withstands the opening force exerted by the gasket onto the sash. The magnetic lock may then be disengaged after the latch has disengaged the eyelet. Consequently, the force that a user needs to apply to the handle bar to alternately engage and disengage and engage the sash is very low, thus adding to user ergonomics and/or comfort.

A graphical representation of an embodiment of an operable magnetic force versus a gasket force is set forth in FIG. 8. In this representation, a gasket force line L is shown graphically as a dashed line, while the magnetic force line is shown in solid line form. On the abscissa is the Aperture Opening Distance starting at the left side at A which represents closure of the aperture at zero distance (i.e., substantially zero distance between the sash and the frame) extending to a point B which is where the gasket force drops to zero representing an open aperture condition (i.e., where the gasket is removed from contact with sash. On the ordinate is the measure of force. Point U represents the maximum closure-resistive force of the gasket, which may be empirically determined and point V represents the amount of closure force of the magnet. Preferably, the magnet 20 will be chosen to have a closure force at least equal but preferably slightly greater than the gasket force (otherwise, the gasket will successfully open the aperture against a lesser magnetic force). The resulting effective closing force is represented by the dotted line, and the effective window closing force is represented by point W.

It may be that the magnetic force is chosen to be greater than the gasket force in all positions of the sash; however, it may be determined that this may not always be so. With a magnetic force, where the gasket force L is larger at least at larger opening distances, another force, typically manual, would need to be applied to overcome the gasket force at least until the magnetic force becomes larger than the gasket force. Then, the magnetic force will be sufficient to hold the window in closed position.

It should be noted that the magnet part 20 may be disposed either on the movable sash, or on the fixed frame, whereas the cooperative magnetically attractive member may be attached to the opposing member, i.e., the frame or the sash contrary to and yet cooperable with the magnetic part.

As to ultimate uses, it may be noted that the window construction of the primary embodiments is a pivot window for installation in an inclined roof, however, the window or other aperture closure member may be installed in any of various orientations in/on a building or other situs for closing a respective aperture.

Preferably, the top, bottom and side members of the frame and sash structures may for the major part be built using wood products, although it is also possible to use metal or plastic. These profiles, particularly those which may be exposed to the weather may also be covered with covering members which are constituted of comparatively thin metal sheet profiles, for instance of aluminum, and which together may provide a completely weather-shielding enclosure of the window. Preferably the hinge(s) 9 and the operable securing/locking means 20 and/or 44 may be made from metallic material, such as steel, or strong plastic materials, such as fiber reinforced plastics or combinations thereof, the primary exceptions being the magnetic and/or magnetically activatable members which may be of magnetic materials. The handle bar assembly 35 may additionally and/or alternatively be made from various combinations of materials including, without limitation, wood, metals and/or plastics.

Although the present invention has been described in detail for purpose of illustration, it is understood that such detail is solely for that purpose, and variations and combinations can be made therein by those skilled in the art without departing from the scope of the appended claims.

1. An assembly for securing an openable aperture closure member (11) in closed position relative to an aperture defined by a main frame (12), said assembly comprising a compressible gasket disposed between the closure member (11) and the frame (12) defining the aperture, wherein each of the aperture closure member (11) and the main frame (12) includes a respective portion (20, 42) of a magnetic means for securing said closure member (11) to the frame (12), wherein said magnetic means for securing includes a magnetic field in one portion (20) and a magnetically attractive portion (42), one of the magnetic field portion and the magnetically attractive portion being disposed on the openable closure member and thus being adapted to be movable by an operator with the openable closure member alternately into a magnetically attractive closure position and a magnetically unattractive opening position and the gasket being at least partially compressed when the closure member (11) is secured to the aperture, and the magnetic locking means (20, 42) overcoming the force needed to compress the gasket.

2. An assembly for securing according to claim 1, wherein the magnetic field portion (20) is disposed on the openable closure member and the magnetically attractive portion (42) is disposed on the main frame.

3. An assembly for securing according to claim 1 wherein the magnetically attractive portion (42) is disposed on the openable closure member and the magnetic field portion (20) is disposed on the main frame.

4. An assembly for securing according to claim 1, wherein the closure member (11) comprises a movable sash structure (13) having horizontal top and bottom members (1, 2) connected by parallel side members (3, 4), said sash structure being accommodated by at least one hinge device (9) in an aperture frame structure (12) with top and bottom members (5, 6) connected by side members (7, 8), wherein the magnetic means (20) is connected to at least one of the top and bottom members (1, 2) or at least one of the parallel side members (3, 4) of the movable sash structure (13).

5. An assembly for securing according to claim 1, wherein the magnetic means (20) is a permanent magnet.

6. An assembly for securing according to claim 1, further comprising an auxiliary locking means (44) for locking the closure member (11) to the frame (12).

7. An assembly for securing according to claim, 6 wherein the auxiliary locking means (44) for securing said closure member (11) to the frame (12) is a hooking member (44).

8. An assembly for securing according to claim 1, further comprising a mechanical locking means (43, 44) for securing said closure member (11) to the frame (12); said assembly being configured to first engage the magnetic locking (20, 42) means and thereafter the mechanical locking means (43, 44) to secure the closure member (11) to the aperture defined by the frame (12) and said assembly being configured to first disengage the mechanical locking (43, 44) means and thereafter the magnetic locking means (20, 42) to release the closure member (11) relative to the aperture.

9. An assembly for securing according to claim 1, wherein the magnetic means provides a force profile which is in the closed position greater than the repulsion force of the gasket.

10. An assembly for securing according to claim 1, wherein the magnetic means provides a force profile is in a range of slightly open positions greater than the repulsion force of the gasket.

11. An assembly for securing according to claim 1, wherein the magnetic means provides a force profile which is greater than the repulsion force of the gasket at least at about the point of closure of the aperture closure member relative to the aperture.

12. An assembly for securing according to claim 1, further comprising a mechanical locking means (43, 44) for securing said closure member (11) to the frame (12); said assembly being configured to first engage the magnetic locking (20, 42) means and thereafter the mechanical locking means (43, 44) to secure the closure member (11) to the aperture defined by the frame (12) and said assembly being configured to first disengage the mechanical locking means (43, 44) and thereafter the magnetic locking means (20, 42) to release the closure member (11) relative to the aperture whilst the mechanical locking means (43, 44) engage and disengage with the closure member (11) in a slightly open position in which the gasket is substantially uncompressed.

13. A method for securing and releasing an openable aperture closure member (11) in closed position relative to an aperture defined by a main frame (12), one of the aperture closure member (11) and the main frame (12) including a magnetic means (20, 42) for securing said closure member (11) to the frame (12); a compressible gasket between the closure member (11) and the aperture, the method being characterized by: substantially translationally moving at least a portion of a magnetic assembly (20, 42) toward another portion of the magnetic assembly (20, 42); alternately securing and/or releasing an openable aperture closure member (11) in closed position relative to an aperture defined by a main frame (12) with the gasket at least partially compressed by the alternate engaging and/or releasing of the magnetic assembly (20, 42).

14. A method according to claim 13, wherein the assembly—further includes a mechanical locking means (43, 44) for securing said closure member (11) to the frame (12); said method further comprises the steps of: first engaging the magnetic locking (20, 42) means and thereafter the mechanical locking means (43, 44) when securing the closure member (11) to the aperture defined by the frame (12), and first disengage the mechanical locking (43, 44) means and thereafter the magnetic locking means (20, 42) to release the closure member (11) relative to the aperture when disengaging the closure member (11) from the aperture defined by the frame (12).
